(19) United States
(12) Patent Application Publication
(10) Pub. No.: US 2003/0026502 A1
(43) Pub. Date: Feb. 6, 2003

(54) Pattern generating and adjustment apparatus and method

(75) Inventor: Masanori Fujiwara, Saitama-ken (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/196,904

(22) Filed: Jul. 15, 2002

(30) Foreign Application Priority Data
Jul. 16, 2001 (JP) P2001-215841

(51) Int. Cl. G06K 9/36; G06K 9/32

(52) U.S. Cl. 382/294; 382/287

(57) ABSTRACT

A pattern generating and adjustment apparatus and method for generating and adjusting patterns on a display includes a first pattern generator generating a first signal on the display as a first pattern and a second pattern generator generating a second signal on the display as a second pattern. A characteristic of the first pattern is different from a characteristic of the second pattern and when properly adjusted, the first and second patterns form an aggregate pattern having a recognizable shape. The recognizable shape may be, for example, an aggregate cross shape combining two differently shaped patterns. The first and second patterns on the display may be properly adjusted by manually or automatically aligning the first and second patterns into the recognizable shape. When properly adjusted, there is no overlap of the first and second patterns, making a manual adjustment, for example a convergence adjustment, easier and faster.

### RELATED APPLICATIONS

This application is based upon and claims the benefit of priority from the prior Japanese Patent Application No. P2001-215841, filed on Jul. 16, 2001, the entire contents of which are incorporated herein by reference.

### BACKGROUND OF THE INVENTION

1. Field of the Invention

The present invention relates to an image display device of a color television set or a projection type television set. Particularly it relates to a convergence adjustment of two or more pattern signals for displaying two or more patterns on the screen of a display device.

2. Description of Related Art

In recent years, consumer demand for large sized and high image quality display devices has increased. Because of that, engineering development of such devices has been accelerated. In the projection tube type color projectors, image signals indicative of three elementary colors, red, green and blue (R, G and B), are supplied to R, G and B projection tubes, respectively, and images projected from the projection tubes are superposed upon each other on a screen, thereby creating a color image. However, since the projection tubes are positioned at different angles relative to the screen, misconvergence may occur in the color image. Thus, it is necessary to perform a convergence adjustment. A convergence adjustment corrects the misconvergence by supplying a correction signal to a coil to make it generate a magnetic field for correcting the misconvergence and thereby to control the direction of deflection of electron beams emitted from the tube.

Various convergence adjustment patterns may be used during the convergence adjustment process. Examples of such convergence adjustment patterns are shown in FIGS. 1(a), 1(b) and 1(c). FIG. 1(a) shows two crosshatch patterns displayed on a screen of a display device for convergence adjustment. Crosshatch pattern 40 is projected on the screen of the display device by, for example, a G projection tube, while the same crosshatch pattern 41 (slightly displaced in position) is projected on the screen of the display device by, for example, an R projection tube. Similarly, FIG. 1(b) shows a dot pattern 42 projected by a first projection tube and the same dot pattern 43 (slightly displaced in position) projected by a second projection tube, while FIG. 1(c) shows a cross-shaped pattern 44 projected by a first projection tube and the same cross-shaped pattern 45 (slightly displaced in position) projected by a second projection tube.

In FIG. 1(a) the intersection points of the horizontal and vertical lines define convergence adjustment points. Similarly, in FIG. 1(b) the center of each dot defines a convergence adjustment point, while in FIG. 1(c) the center of each cross defines a convergence adjustment point. These convergence adjustment patterns with their respective convergence adjustment points, when displayed on a screen of the display device, enable a user of the display device to perform convergence adjustment to correct any misconvergence. An example of a known technique for convergence adjustment is shown in Japanese Patent Laid-Open NO. 212779/1995.

Generally, because of its high brightness, the color green is normally used as a is reference during the convergence adjustment, and the colors blue and red are adjusted in relation to the color green. Therefore, a first pattern, for example the crosshatch pattern 40, will be projected on the screen of the display device by the G projection tube. The crosshatch pattern 41 will then be projected on the screen of the display device by the R or B projection tubes. The adjustment points of crosshatch pattern 41 are then adjusted in relation to the adjustment points of the fixed crosshatch pattern 40. Proper adjustment is achieved when the adjustment points of crosshatch pattern 41 overlap the adjustment points of crosshatch pattern 40.

Similarly, dot pattern 42 or cross-shaped pattern 44 may first be projected on the screen of the display device by the G projection tube. Then dot pattern 43 or cross-shaped pattern 45 will be projected on the screen of the display device by the R or B projection tubes and its adjustment points adjusted so that they overlap fixed dot pattern 42 or cross-shaped pattern 44, respectively

In one method for convergence adjustment, a camera may capture an image on the screen of the display device and provide the image as an input to a processing device. The processing device may, in turn, perform the convergence adjustment based on the received image. This method is used most often during the manufacturing process. Alternatively, a convergence adjustment may be performed by a user of the display device while viewing the convergence adjustment pattern on the screen of the display device and manually entering convergence adjustment information for each convergence adjustment point by means of an input device, for example a keyboard or remote controller.

In the latter method, a user manually performs convergence adjustment so that convergence adjustment points on separate convergence adjustment patterns projected by the R, G and B projection tubes are superposed on (that is, overlap) one another so that all like parts coincide. In this case, the user views the convergence adjustment patterns on the screen of the display device as the convergence adjustment is made by the user, and the user tries to determine subjectively when the convergence adjustment points of the separate R, G, and B patterns are superposed on one another. However, users are generally limited in their ability to accurately determine when such superposition occurs. Thus, the convergence adjustment may not be accurate. In addition, because of this limitation, manual convergence adjustment for the various convergence adjustment points on the screen of the display device is time consuming.

One reason why it is difficult to accurately determine when such superposition occurs is that beam diameter, shape, and focus may vary between the R, G, and B projection tubes as they project on different parts of the screen. As an example, the beam diameter output from the R projection tube may be smaller than the beam diameter output from the G projection tube. Because of this, the display region of beam output from the R projection tube may be within, but not centered within, the display region of beam output from the G projection tube. Thus, it may be difficult to judge the beam position of the R projection tube. Furthermore, it is generally known that B is more difficult to focus than G and R. Thus, it is difficult to manually superpose the B pattern over the G or R patterns because it is difficult for the user to determine when such superposition occurs.

The present invention addresses the problems described above, wherein using present methods, manual convergence adjustment is difficult to perform accurately and is very time consuming.

### SUMMARY OF THE INVENTION

Embodiments of the present invention provide an apparatus and method for easily, quickly and accurately performing an adjustment of two or more signals, and in preferred embodiments to an apparatus and method for easily, quickly and accurately performing a convergence adjustment on two or more pattern signals for displaying two or more patterns on the screen of a display device.

According to embodiments of the present invention, there is provided a pattern generating and adjustment apparatus for generating and adjusting patterns on a display screen, comprising a first pattern generator generating a first signal on the display screen as a first pattern; a second pattern generator generating a second signal on the display screen as a second pattern; and means for properly adjusting the first and second patterns on the display screen. A characteristic other than color of the first pattern is different from a corresponding characteristic of the second pattern and when properly adjusted, the first and second patterns form an aggregate pattern having a recognizable shape.

Embodiments of the present invention generate patterns that differ from one another by various characteristics such as, but not limited to, shape, size, fill pattern, and orientation. The differing patterns may be aligned into an aggregate pattern with a recognizable shape. In one embodiment, The recognizable shape comprises a cross shape including at least one substantially straight line. In another embodiment, the recognizable shape comprises an aggregation of the first and second patterns wherein the first pattern has an opening with a particular shape, the opening being substantially filled by the second pattern, the second pattern having the particular shape.

According to embodiments of the present invention, when properly adjusted, at least a portion of the first pattern does not overlap the second pattern. Thus, a user may easily, quickly and accurately determine when the patterns are aligned without having to determine when the patterns are superposed on one another.

According to other embodiments of the present invention, there is provided a pattern generating and adjustment apparatus for generating and adjusting patterns on a display screen, comprising a first pattern generator generating a first signal on the display screen as a first pattern; a second pattern generator generating a second signal on the display screen as a second pattern; and means for properly adjusting the first and second patterns on the display screen. A characteristic of the first pattern is different from a corresponding characteristic of the second pattern and when properly adjusted, the first and second patterns form an aggregate pattern having a recognizable shape, the recognizable shape having at least a portion of the first pattern which does not overlap the second pattern. The patterns differ from one another by various characteristics such as, but not limited to, shape, size, fill pattern, color and orientation. In one embodiment, the recognizable shape has no portion of the first and second patterns overlapping one another.

According to other embodiments of the present invention, there is provided an apparatus having a display screen for displaying pattern signals, comprising a pattern generator generating and displaying a plurality of signals on the display screen as a plurality of patterns. At least one of the plurality of patterns has at least one characteristic different from at least one corresponding characteristic of at least one other of the plurality of patterns. The characteristics may include shape, size, fill pattern, and orientation. When properly adjusted, an aggregate pattern having a recognizable shape is formed.

Means are provided for determining an adjustment quantity required for proper adjustment of at least one of the plurality of patterns. Further means are provided for properly adjusting an alignment of the at least one of the plurality of patterns on the display screen according to the determined adjustment quantity. A memory device is also provided for storing the adjustment quantity.

In one embodiment, after the patterns are generated on the display screen, a user may easily determine an adjustment quantity required for proper convergence by visualizing a vertical and horizontal axis of each of the displayed patterns. When the vertical and horizontal axes of the displayed patterns are aligned by the user and the recognizable shape is formed, proper convergence has been achieved. The user may manually align the patterns while viewing them on the display screen using an input device such as, but not limited to, a keyboard or a remote control.

In another embodiment, after the patterns are generated on the display screen, a camera or other image capture device may capture an image of the display screen and provide the image as an input to a processing device. The processing device may then determine the adjustment quantity and perform the adjustment based on the adjustment quantity.

The adjustment quantity may be stored in the memory device. The adjustment quantity may then be used, for example, to provide convergence adjustment signals to a display means such as, but not limited to, a cathode ray tube (CRT) of a color television set or projection tubes for projecting G, R and B signals to the display screen of a projection type television.

### BRIEF DESCRIPTION OF THE DRAWINGS

The present invention is illustrated by way of example, and not by way of limitation, in the figures of the accompanying drawings and in which:

FIG. 1(a) shows a conventional convergence adjustment crosshatch pattern;

FIG. 1(b) shows a conventional convergence adjustment dot pattern;

FIG. 1(c) shows a conventional convergence adjustment cross pattern;

FIG. 2(a) shows an aggregate cross pattern combining two different patterns and indicating proper convergence of two colors on the screen of a display device, according to embodiments of the present invention;

FIG. 2(b) shows two different patterns indicating poor convergence of two colors on the screen of a display device, according to embodiments of the present invention;

FIG. 2(c) shows two different patterns indicating poor focusing of one color and poor convergence of two colors on the screen of a display device, according to embodiments of the present invention;

FIG. 3(a) shows an aggregate cross pattern combining three different patterns and indicating proper convergence of three colors on the screen of a display device, according to embodiments of the present invention;

FIG. 3(b) shows three different patterns indicating poor convergence of three colors on the screen of a display device, according to embodiments of the present invention;

FIG. 3(c) shows an aggregate cross pattern combining two different patterns and indicating proper convergence of two colors on the screen of a display device, according to embodiments of the present invention;

FIG. 3(d) shows two different patterns indicating poor convergence of two colors on the screen of a display device, according to embodiments of the present invention;

FIG. 4(a) shows an aggregate pattern combining two different patterns and indicating proper convergence of two colors on the screen of a display device, according to embodiments of the present invention;

FIG. 4(b) shows two different patterns indicating poor convergence of two colors on the screen of a display device, according to embodiments of the present invention;

FIG. 5 shows a block diagram of an image display device, according to embodiments of the present invention;

FIG. 6 shows a block diagram of a digital convergence portion of the image display device, according to embodiments of the present invention;

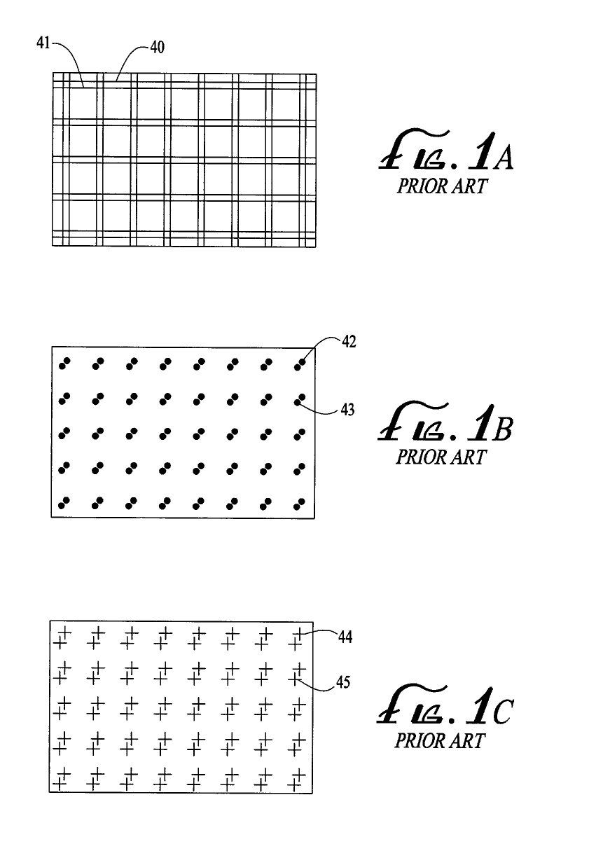

### DETAILED DESCRIPTION OF THE INVENTION

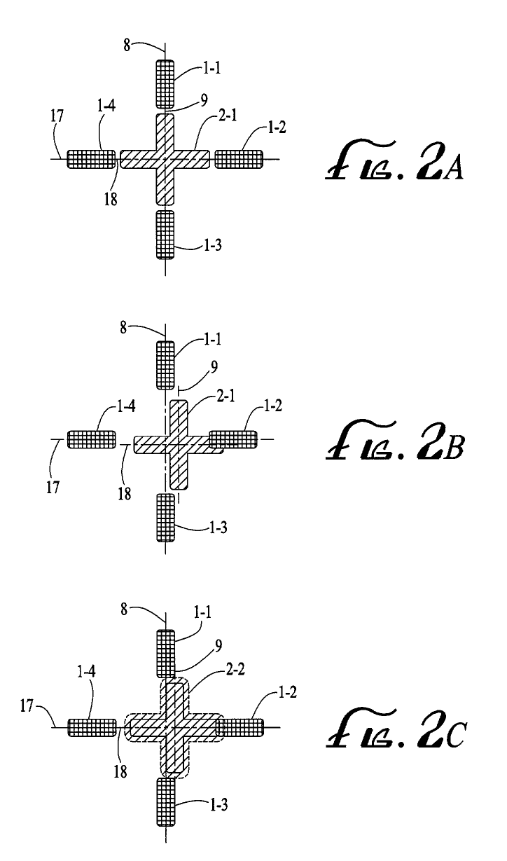

Embodiments of the present invention will be described in detail referring to the figures. First, a convergence adjustment method according to a first embodiment of the present invention will be described. FIG. 2(a) shows convergence adjustment patterns to be displayed on the screen of the display device according to a first embodiment of the invention. Two or more patterns having various characteristics such as, but not limited to, shape, size, color, fill pattern and orientation, are projected on the screen of the display device. The patterns shown in FIG. 2(a) are not limited to use in convergence adjustment, but may be used for other purposes, such as for adjustment of other signal processes.

A cross-shaped pattern 2-1 is projected on the screen of the display device by one of the R, B, G projection tubes. Bar-shaped patterns 1-1, 1-2, 1-3, and 1-4 are projected on the screen of the display device by another of the R, B, G projection tubes. The cross-shaped pattern 2-1 may include a first fill pattern such as the diagonal line pattern shown in FIG. 2(a), while the bar-shaped patterns 1-1, 1-2, 1-3, and 1-4 may include a second fill pattern such as the crosshatch pattern shown in FIG. 2(a). The different fill patterns help the user to easily differentiate between the cross-shaped pattern 2-1 and the bar-shaped patterns 1-1, 1-2, 1-3, and 1-4 on the screen of the display device. As stated above, during the convergence adjustment the color green is normally used as a reference, and colors blue and red are adjusted in relation to green. Therefore, the cross-shaped pattern 2-1 will be projected on the screen of the display device by the G projection tube. The bar-shaped patterns 1-1, 1-2, 1-3, and 1-4 will then be aligned in relation to the fixed cross-shaped pattern 2-1. The bar-shaped patterns 1-1, 1-2, 1-3, and 1-4 are projected on the screen of the display device by, for example, the R projection tube.

A user performs the following convergence adjustment using the patterns. Using an input device such as a keyboard or remote control, the user may first cause the cross-shaped pattern 2-1 of the G projection tube to be displayed on the screen of the display device. The user may then adjust the G pattern such that the center of the cross-shaped pattern 2-1 is located in a particular position on the screen of the display device (screen for convergence adjustment). After adjusting the G pattern, it will generally remain fixed for the remainder of the convergence adjustment process. Typically, the factory adjustment will be utilized for green. The user then causes the bar-shaped patterns 1-1, 1-2, 1-3, and 1-4 of the R projection tube to be displayed on the screen of the display device.

FIG. 2(a) shows the positions of the G and R patterns after a convergence adjustment has been performed. When proper convergence is achieved, an aggregate cross-shaped pattern combining the cross-shaped pattern 2-1 and the bar-shaped patterns 1-1, 1-2, 1-3, and 1-4 is formed on the screen of the display device. Although the cross-shaped pattern 2-1 and the bar-shaped patterns 1-1, 1-2, 1-3, and 1-4 are combined to form the aggregate cross-shaped pattern, when proper convergence is achieved the two different patterns are not superposed on one another. Thus, it is easier for the user to accurately and quickly determine when proper convergence adjustment has been achieved, as described below.

Accurate convergence adjustment in the horizontal direction is easily achieved by aligning a vertical center axis line 8 of the bar-shaped patterns 1-1 and 1-3 of R with a vertical center axis line 9 of the cross-shaped pattern 2-1 of G. Similarly, accurate convergence adjustment in the vertical direction is easily achieved by aligning a horizontal center axis line 17 of the bar-shaped patterns 1-2 and 1-4 of R with a horizontal center axis line 18 of the cross-shaped pattern 2-1 of G. Vertical center axis lines 8, 9 and horizontal center axis lines 17, 18 are not actually shown on the screen, but may be easily visualized by the user. When the vertical and horizontal alignment is complete, the aggregate cross-shaped pattern formed by the cross-shaped pattern 2-1 and the bar-shaped patterns 1-1, 1-2, 1-3, and 1-4 comprises substantially straight lines in the vertical and horizontal directions, as shown in FIG. 2(a). This aggregate cross-shaped pattern indicates that proper convergence of the G and R patterns has been achieved by the user.

FIG. 2(b) shows an example of poor convergence. The vertical and horizontal center lines of the cross-shaped pattern 2-1 and the bar-shaped patterns 1-1, 1-2, 1-3, and 1-4 are not aligned. Thus, the aggregate cross-shaped pattern formed by the cross-shaped pattern 2-1 and the bar-shaped patterns 1-1, 1-2, 1-3, and 1-4 does not consist of substantially straight lines in the vertical and horizontal directions. The user may, therefore, easily recognize that the G and R convergence is poor. Using the patterns shown in FIG. 2(b), the user can visually estimate and perform the vertical and horizontal adjustment required to achieve proper convergence. For example, the user may measure the horizontal convergence shift of FIG. 2(b). That is, the user may measure the distance between vertical center axis line 8 of the bar-shaped patterns 1-1 and 1-3 of R and vertical center axis line 9 of the cross-shaped pattern 2-1 of G by visually estimating the distance between vertical center axis lines 8 and 9. In this way, the user may roughly measure the quantity of adjustment required and perform the horizontal convergence adjustment easily and objectively. Similarly, the user may measure the vertical convergence shift of FIG. 2(b). That is, the user may measure the distance between horizontal center axis line 17 of the bar-shaped patterns 1-2 and 1-4 of R and horizontal center axis line 18 of the cross-shaped pattern 2-1 of G by visually estimating the distance between horizontal center axis lines 17 and 18. In this way, the user may roughly estimate the quantity of adjustment required and perform the vertical convergence adjustment easily and objectively.

FIG. 2(c) shows another example of poor convergence. FIG. 2(c) differs from FIG. 2(b) in that cross-shaped pattern 2-1 is poorly focused. It can be seen from FIG. 2(c) that even when cross-shaped pattern 2-1 is poorly focused it is easy for the user to visually recognize the vertical and horizontal distances between the center axis lines of the cross-shaped pattern 2-2 and bar-shaped patterns 1-1, 1-2, 1-3, and 1-4. Thus, the user may perform a convergence adjustment to form an aggregate cross-shaped pattern consisting of substantially straight lines in the vertical and horizontal directions using the cross-shaped pattern 2-1 and the bar-shaped patterns 1-1, 1-2, 1-3, and 1-4. It is noted that when properly adjusted as shown in FIG. 2(a) the cross-shaped pattern 2-1 does not overlap the bar-shaped patterns 1-1, 1-2, 1-3, and 1-4.

In the first embodiment of the present invention described above, the cross-shaped pattern 2-1 is projected on the screen of the display device by the G projection tube and the bar-shaped patterns 1-1, 1-2, 1-3, and 1-4 are projected on the screen of the display device by the R projection tube. Generally, the above-described adjustment process would be repeated for the B projection tube. That is, cross-shaped pattern 2-1 may be projected on the screen of the display device by the G projection tube and bar-shaped patterns 1-1, 1-2, 1-3, and 1-4 may be projected on the screen of the display device by the B projection tube. Thus, the adjustment of the R and B projection tubes may be performed sequentially in relation to the fixed cross-shaped pattern 2-1 projected on the screen of the display device by the G projection tube. Although B has a lower brightness than G, convergence adjustment using a pattern projected on the screen of the display device by the B projection tube may be performed easily and quickly using the embodiment of the present invention described above. By employing suitable combinations of patterns of G, R, and B convergence of all three colors on the screen of the display device may be achieved in the manner described above.

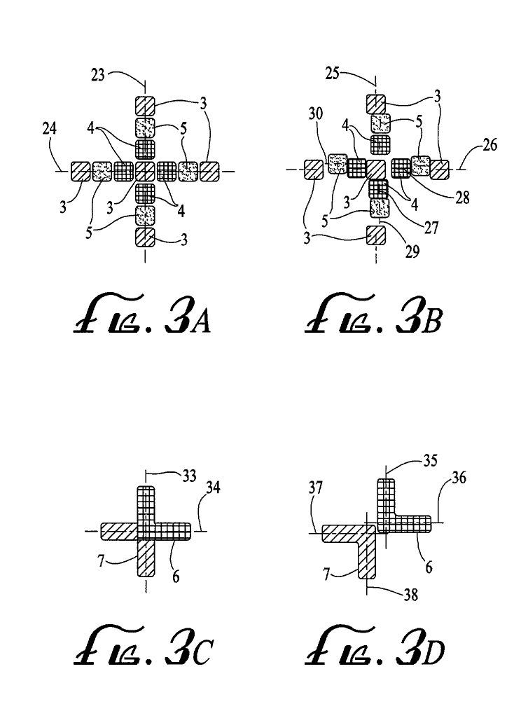

FIGS. 3(a) and 3(b) show patterns for convergence adjustment according to a second embodiment of the present invention. FIG. 3(a) shows a convergence adjustment pattern to be displayed on the screen of the display device. Here, a pattern for convergence adjustment is projected on the screen of the display device by each of the R, G, and B projection tubes. Pattern 3 is projected on the screen of the display device by the G projection tube. Pattern 4 is displayed on the screen of the display device by the R projection tube. Pattern 5 is displayed on the screen of the display device by the B projection tube. Patterns 3, 4 and 5 each consist of a cross-shaped pattern having four blocks equidistantly located from the center of the cross-shaped pattern. The distance of the blocks from the center of the cross-shaped pattern varies between each of patterns 3, 4 and 5. Thus, the size characteristic of patterns 3, 4 and 5 varies. Pattern 3 additionally includes a fifth block located at its center. The blocks of patterns 3, 4 and 5 may include different fill patterns to help the user to easily differentiate between patterns 3, 4 and 5 on the screen of the display device. For example, the blocks of pattern 3 may include a first fill pattern such as a diagonal line pattern, while the blocks of patterns 4 and 5 may include second and third fill patterns such as a crosshatch pattern and dot pattern, respectively, as shown in FIGS. 3(a) and 3(b).

A user performs the following convergence adjustment using the patterns 3, 4 and 5. The user may first adjust the pattern 3 such that the center block of pattern 3 is located in a designated position on the screen of the display device (screen for convergence adjustment). After adjusting pattern 3, the user may align patterns 4 and 5 with pattern 3, as described below.

FIG. 3(a) shows the positions of patterns 3, 4 and 5 after a convergence adjustment has been performed. When proper convergence is achieved, an aggregate cross-shaped pattern combining patterns 3, 4 and 5 is formed on the screen of the display device. Although patterns 3, 4 and 5 are combined to form the aggregate cross-shaped pattern, when proper convergence is achieved the three different patterns are not superposed on one another. Thus, it is easier for the user to accurately and quickly determine when proper convergence adjustment has been achieved, as described below.

Accurate convergence adjustment in the horizontal and vertical directions is easily achieved by arranging patterns 3, 4 and 5 into an aggregate cross-shaped pattern having a vertical center axis line 23 and a horizontal center axis line 24, as shown in FIG. 3(a). Vertical center axis line 23 and horizontal center axis line 24 are not actually shown on the screen, but may be easily visualized by the user. When the adjustment is complete, the aggregate cross-shaped pattern comprises substantially straight lines in the vertical and horizontal directions, as shown in FIG. 3(a). This aggregate cross-shaped pattern indicates that proper convergence of patterns 3, 4 and 5 has been achieved by the user.

FIG. 3(b) shows an example of poor convergence. As shown in FIG. 3(b), in each of the patterns 3, 4 and 5 the user may visualize a horizontal center axis line and a vertical center axis line. Thus, pattern 3 includes vertical center axis line 25 and horizontal center axis line 26. Similarly, pattern 4 includes vertical center axis line 27 and horizontal center axis line 28 and pattern 5 includes vertical center axis line 29 and horizontal center axis line 30. Vertical center axis lines 25, 27, 29 and horizontal center axis lines 26, 28, 30 are not actually shown on the screen, but may be easily visualized by the user.

It is seen in FIG. 3(b) that the vertical and horizontal center axis lines of patterns 3, 4 and 5 are not aligned. Thus, the aggregate cross-shaped pattern formed by patterns 3, 4, and 5 does not consist of substantially straight lines in the vertical and horizontal directions. The user may, therefore, easily recognize that the convergence of patterns 3, 4 and 5 is poor. Using the patterns shown in FIG. 3(b), the user can visually estimate and perform the vertical and horizontal adjustments required to achieve proper convergence. For example, the user may measure the horizontal convergence shift between patterns 3, 4 and 5 of FIG. 3(b). That is, the user may estimate the distance between vertical center axis lines 27 and 29 of patterns 4 and 5, respectively, and the vertical center axis line 25 of pattern 3. In this way, the user may estimate the quantity of adjustment required and perform the horizontal convergence adjustment easily and objectively. Similarly, the user may measure the vertical convergence shift between patterns 3, 4 and 5 of FIG. 3(b). That is, the user may estimate the distance between horizontal center axis lines 28 and 30 of patterns 4 and 5, respectively, and the horizontal center axis line 26 of pattern 3. In this way, the user may estimate the quantity of adjustment required and perform the vertical convergence adjustment easily and objectively.

FIGS. 3(c) and 3(d) show patterns for convergence adjustment according to a third embodiment of the present invention. FIG. 3(c) shows an aggregate cross-shaped pattern consisting of L shaped pattern 6 and reverse inverted L shaped pattern 7 displayed on the screen of the display device (screen for convergence adjustment). The two patterns thus have different orientation characteristics. L shaped pattern 6 may be projected on the screen of the display device by, for example, the R projection tube. Reverse inverted L shaped pattern 7 may be projected on the screen of the display device by, for example, the G projection tube. The L shaped pattern 6 may include a first fill pattern such as the crosshatch pattern, while the reverse inverted L shaped pattern 7 may include a second fill pattern such as the diagonal line pattern, as shown in FIGS. 3(c) and 3(d). The different fill patterns help the user to easily differentiate between the L shaped pattern 6 and the reverse inverted L shaped pattern 7 on the screen of the display device.

FIG. 3(c) shows the positions of patterns 6 and 7 after a convergence adjustment has been performed. When proper convergence is achieved, an aggregate cross-shaped pattern combining patterns 6 and 7 is formed on the screen of the display device. Although patterns 6 and 7 are combined to form the aggregate cross-shaped pattern, when proper convergence is achieved the two different patterns are only partially superposed on one another. Thus, it is easier for the user to accurately and quickly determine when proper convergence adjustment has been achieved, as described below.

Accurate convergence adjustment in the horizontal and vertical directions is easily achieved by arranging patterns 6 and 7 into an aggregate cross-shaped pattern having a vertical center axis line 33 and a horizontal center axis line 34, as shown in FIG. 3(c). Vertical center axis line 33 and horizontal center axis line 34 are not actually shown on the screen, but may be easily visualized by the user. When the adjustment is complete, the aggregate cross-shaped pattern comprises substantially straight lines in the vertical and horizontal directions, as shown in FIG. 3(c). This aggregate cross-shaped pattern indicates that proper convergence of patterns 6 and 7 has been achieved by the user.

FIG. 3(d) shows an example of poor convergence. As shown in FIG. 3(d), in each of the patterns 6 and 7 the user may visualize a horizontal center axis line and a vertical center axis line. Thus, pattern 6 includes vertical center axis line 35 and horizontal center axis line 36. Similarly, pattern 7 includes vertical center axis line 37 and horizontal center axis line 38. Vertical center axis lines 35, 37 and horizontal center axis lines 36, 38 are not actually shown on the screen, but may be easily visualized by the user.

It is seen in FIG. 3(d) that the vertical and horizontal center axis lines of patterns 6 and 7 are not aligned. Thus, the aggregate cross-shaped pattern formed by patterns 6 and 7 does not consist of substantially straight lines in the vertical and horizontal directions. The user may, therefore, easily recognize that the convergence of patterns 6 and 7 is poor. Using the patterns shown in FIG. 3(d), the user can visually estimate and perform the vertical and horizontal adjustments required to achieve proper convergence. For example, the user may measure the horizontal convergence shift between patterns 6 and 7 of FIG. 3(d). That is, the user may estimate the distance between vertical center axis line 35 of pattern 6 and the vertical center axis line 38 of pattern 7. In this way, the user may estimate the quantity of adjustment required and perform the horizontal convergence adjustment easily and objectively. Similarly, the user may measure the vertical convergence shift between patterns 7 and 7 of FIG. 3(d). That is, the user may estimate the distance between horizontal center axis lines 36 of pattern 6 and the horizontal center axis line 37 of pattern 7. In this way, the user may estimate the quantity of adjustment required and perform the vertical convergence adjustment easily and objectively.

Embodiments of the present invention described above relate to a method of convergence adjustment employing two or more differently shaped patterns that may be manually adjusted in such a manner that they form an aggregate cross-shaped pattern consisting of substantially straight lines in the vertical and horizontal directions. When proper convergence is achieved at least some portions of the two or more different patterns are not superposed on one another. The user may, therefore, easily recognize when the convergence of the patterns is poor and may easily adjust the patterns to achieve proper convergence.

Although the embodiments above were described in relation to two or more patterns having different characteristics such as shape, size or pattern fill, the possible characteristics of the pattern are not so limited. Other characteristics such as pattern color or pattern orientation may also be used. In addition, Although the embodiments above were described in relation to two or more different patterns that form an aggregate cross shaped pattern when proper convergence is achieved, this is not a limitation. The aggregate pattern formed when proper convergence is achieved, according to embodiments of the present invention, may also consist of an aggregate pattern of a different shape. In fact, any two or more patterns having different characteristics may be used that, when adjusted in a manner that indicates proper convergence, form a recognizable shape wherein the two or more patterns are not superposed on one another.

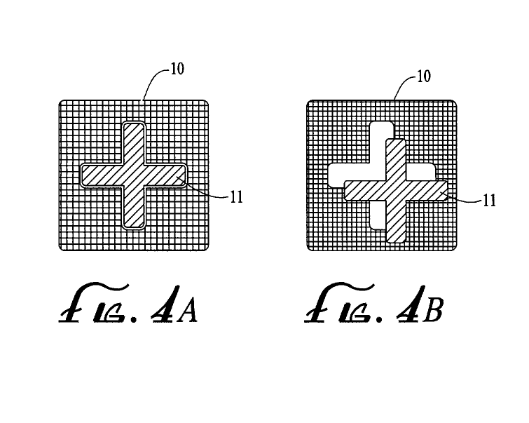

FIGS. 4(a) and 4(b) show patterns for convergence adjustment according to a fourth embodiment of the present invention. FIG. 4(a) shows an aggregate pattern consisting of pattern 10 and pattern 11 displayed on the screen of the display device (screen for convergence adjustment). Pattern 10 for convergence adjustment consists of a substantially rectangular shape having a cross-shaped opening in its center part. Pattern 11 for convergence adjustment is a cross-shaped pattern having substantially the same dimensions as the cross-shaped opening in the center part of pattern 10. Pattern 10 may include a first fill pattern such as the crosshatch pattern, while pattern 11 may include a second fill pattern such as the diagonal line pattern, as shown in FIGS. 4(a) and 4(b). The different fill patterns help the user to easily differentiate between patterns 10 and 11 on the screen of the display device. Pattern 10 may be projected on the screen of the display device by, for example, the G projection tube. Pattern 11 may be projected on the screen of the display device by, for example, the R or B projection tube.

FIG. 4(a) shows the positions of patterns 10 and 11 after a convergence adjustment has been performed. When proper convergence is achieved, an aggregate pattern combining patterns 10 and 11 is formed on the screen of the display device. The aggregate pattern comprises pattern 10 having its cross-shaped opening substantially filled in by cross-shaped pattern 11. Although patterns 10 and 11 are combined to form the aggregate pattern, when proper convergence is achieved the two different patterns are not superposed on one another. Thus, it is easier for the user to accurately and quickly determine when proper convergence adjustment has been achieved, as described below.

Accurate convergence adjustment in the horizontal and vertical directions is achieved by arranging patterns 10 and 11 into an aggregate pattern having the cross-shaped opening of pattern 10 substantially filled in by cross-shaped pattern 11 with no overlap of the patterns 10 and 11. This aggregate pattern indicates that proper convergence of patterns 10 and 11 has been achieved by the user.

FIG. 4(b) shows an example of poor convergence. As shown in FIG. 4(b), the cross-shaped opening in the center of pattern 10 is not substantially filled in by pattern 11. Thus, the user may, therefore, easily recognize that the convergence of patterns 10 and 11 is poor. Using the patterns shown in FIG. 4(b), the user can visually perform the vertical and horizontal adjustments required to achieve proper convergence by aligning pattern 11 with pattern 10 such that the cross-shaped opening of pattern 10 is substantially filled in by cross-shaped pattern 11.

In a further embodiment (not shown), pattern 10 may include a plurality of cross-shaped openings in its center part. A plurality of cross-shaped patterns having dimensions substantially the same as the dimensions of the plurality of cross-shaped openings may be projected on the screen of the display device by, for example, the R and B projection tubes. The user can visually perform the vertical and horizontal adjustments required to achieve proper convergence by aligning the plurality of cross-shaped patterns with pattern 10 such that the plurality of cross-shaped openings of pattern 10 are substantially filled in by the plurality of cross-shaped patterns. Thus, convergence adjustment of three colors (RGB) may be performed sequentially.

In the fourth embodiment of the present invention described above, the openings and patterns are cross-shaped. However, the invention is not so limited. It is possible to perform convergence adjustment employing other suitable shapes, such as, but not limited to, circles, squares, and the like. In addition, according to embodiments of the invention, the patterns described are used for convergence adjustment. However, it is possible to apply embodiments of the present invention to any signal adjustment requiring adjustment between plural signals. In addition, although according to embodiments of the invention, the user manually performs the convergence adjustment, the embodiments of the invention described above may be used in an automated convergence adjustment process wherein an image of the patterns on the screen of the display device is inputted to a processing device programmed to determine an adjustment quantity and to adjust the signal.

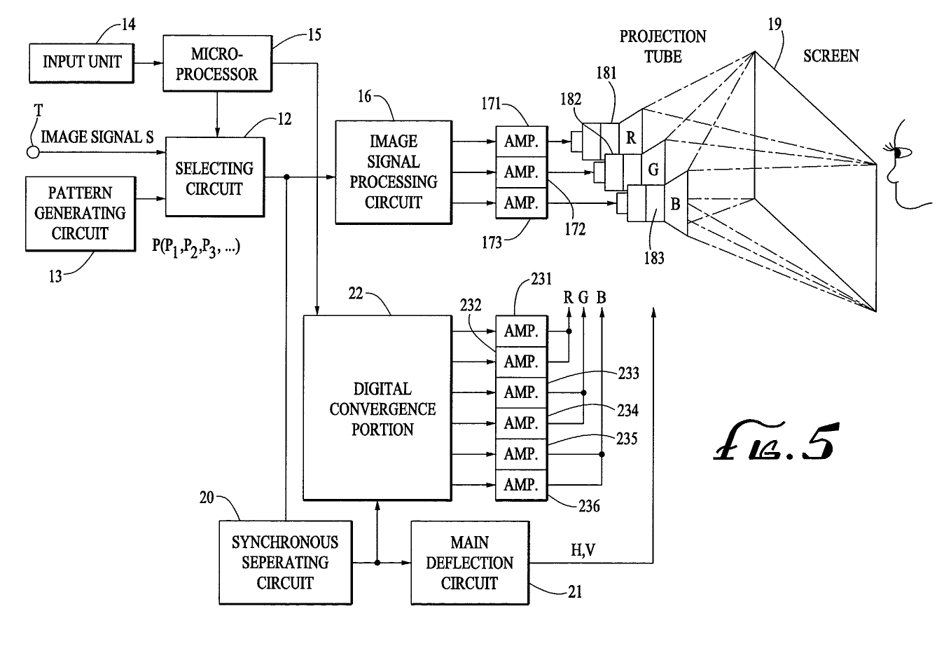

Next, an image display device according to embodiments of the present invention will be described in detail in relation to FIG. 5. FIG. 5 shows a block diagram of a projection television set (display device). Image signal S is input to an input terminal T. The image signal S may be applied from an external part of the projection television, or a built-in tuner (not shown). After that, the image signal S is supplied to a selecting circuit 12. A pattern generating circuit 13 generates a pattern signal for convergence adjustment. The pattern for convergence adjustment is supplied to the selecting circuit 12 as a pattern signal (image signal) P for convergence adjustment. The user operates an input device 14 and inputs commands for convergence adjustment.

A microprocessor 15 generates command signals based on the commands received from the user via input device 14. The microprocessor 15 transmits the command signals to the selecting circuit 12 and controls the selecting circuit 12. The selecting circuit 12 responds to the commands of the microprocessor and selects one of the image signal S and the pattern signal P for adjustment. The selecting circuit 12 supplies the selected image signal to an image signal processing circuit 16. The image signal processing circuit 16 converts the supplied image signal to R, G, and B signals and supplies them to corresponding amplifying circuits 171, 172, and 173, respectively. The amplifying circuits 171, 172, and 173 amplify the R, G, and B signals, respectively, and supply them to projection tubes 181, 182, and 183 corresponding to each of the three primary colors of R, G, and B. The projection tubes 181, 182, and 183 project beams corresponding to each of R, G, and B to a back face of a screen 19 suitably through an optical system (not shown). Thus, a user can view a picture on the screen 19, where color pictures projected from the projection tubes 181, 182, and 183, respectively, are projected and overlap one another on the screen 19.

The image signal selected at the selecting circuit 12 is further supplied to a synchronous separating circuit 20. The synchronous separating circuit 20 separates a synchronous signal from the image signal and extracts the synchronous signal. The synchronous separating circuit 20 supplies the synchronous signal to a main deflection signal generating circuit 21 and a digital convergence portion 22. The main deflection signal generating circuit 21 generates horizontal (H) and vertical (V) main deflection signals from the supplied synchronous signal. The horizontal (H) and vertical (V) main deflection signals are supplied to each of the input terminals of projection tubes 181, 182, and 183 corresponding to R, G, and B, respectively. Each of input terminals is provided at each of main deflection coils.

Each main deflection coil is attached at a neck of each of the projection tubes 181, 182, and 183. Between each of the projection tubes 181, 182, and 183 and the screen 19, a reflecting mirror (not shown) is suitably arranged. The reflecting mirror directs the picture beam from each of projection tubes 181, 182, and 183 to the screen 19. Using this method, a thin projection television set can be designed. The projection tubes 181, 182, and 183 of R, G, and B are arranged in order and have different positional relationships with the screen 19. That is, the positional relationship of the center projection tube with the screen differs from the positional relationship of the remaining projection tubes. Projected pictures of R, G, and B colors do not overlap correctly on the screen due to this difference in positional relationships and picture distortion results. Therefore, convergence adjustment is performed using the digital convergence portion 22 of the projection television set.

Commands supplied from the microprocessor 15 and the synchronous signal supplied from the synchronous separating circuit 20 are inputted to the digital convergence portion 22. The digital convergence portion 22 generates horizontal (H) and vertical (V) auxiliary deflection signals corresponding to each of the projection tubes 181, 182, and 183 of R, G, and B, and supplies these six kinds of auxiliary deflection signals to amplifying circuits 231, 232, 233, 234, 235, and 236. The amplifying circuits 231, 232, 233, 234, 235, and 236 amplify the six kinds of supplied auxiliary deflection signals, and supply them to the input terminals of the horizontal (H) and vertical (V) auxiliary deflection coils provided at each neck of the projection tubes 181, 182, and 183 of R, G, and B.

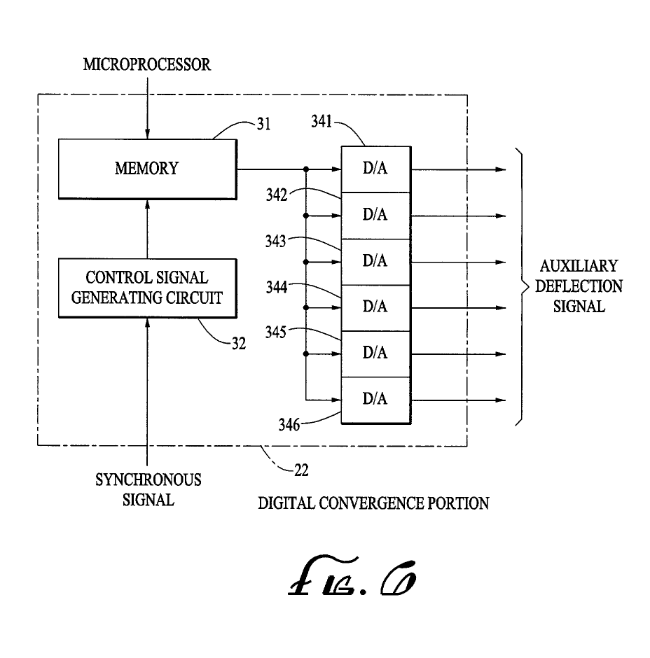

FIG. 6 shows a block diagram of the digital convergence portion 22 according to embodiments of the present invention. The digital convergence portion 22 provides a memory 31 for storing commands supplied from the microprocessor 15. Adjustment signals for each of a plurality of adjustment points arranged in a grid on the screen are stored as digital data in the memory 31. The synchronous signal extracted at the synchronous separating circuit 20 is inputted to a control signal generating circuit 32. The control signal generating circuit 32 generates a control signal from the input synchronous signal and outputs it to the memory 31.

The memory 31 is controlled by the control signal and outputs convergence adjustment data. The adjustment data is input to D/A conversion circuits 341, 342, 343, 344, 345, and 346. The D/A conversion circuits 341, 342, 343, 344, 345, and 346 convert the convergence adjustment data to analog auxiliary deflection signals. The analog auxiliary deflection signals are signals corresponding to horizontal and vertical deflections of each of the projection tubes 181, 182, and 183 of R, G, and B. The analog auxiliary deflection signals are supplied to the amplifying circuits 231, 232, 233, 234, 235, and 236.

A process for convergence adjustment of the projection television set shown in FIG. 5 will now be described. First, the user operates the input device 14 and instructs the microprocessor 15 to initiate the convergence adjustment mode. The microprocessor 15 gives selecting commands to the selecting circuit 12 and selects the pattern signal P supplied for convergence adjustment from the pattern generating circuit 13. The selecting circuit 12 supplies the pattern signals (P1, P2, P3, . . . ) corresponding to the above-mentioned patterns for adjustment to the image signal processing circuit 16 and the synchronous separating circuit 20. The pattern signal P for adjustment at this time may be one pattern signal or may be a plurality of pattern signals P1, P2, and P3.

The pattern generating circuit 13 generates the pattern signals P for the above-mentioned convergence adjustment corresponding to each of the plurality of adjustment points and displays the picture for adjustment on the screen 19. While viewing the picture on screen 19, the user inputs a suitable command to the input device 14 to perform the convergence adjustment for a particular adjustment point, for example by aligning the bar-shaped patterns 1-1, 1-2, 1-3, and 1-4 with the cross-shaped pattern 2-2 at the particular adjustment point, as described in relation to FIGS. 2(a), (b) and (c). Thus, the user may perform a convergence adjustment to form an aggregate cross-shaped pattern consisting of substantially straight lines in the vertical and horizontal directions using the cross-shaped pattern 2-1 and the bar-shaped patterns 1-1, 1-2, 1-3, and 1-4.

The microprocessor 15 receives a signal representing the adjusting quantity supplied from the input device 14, controls the digital convergence portion 22, and adjusts the patterns so as to align them for proper convergence at the adjustment point. That is, when the user operates the input device 14, the input device 14 supplies the signal representing the adjusting quantity to the microprocessor 15. The microprocessor 15 supplies a control signal to the digital convergence portion 22 responding to the adjusting quantity signal. The digital convergence portion 22 changes the screen coordinates of the pattern for convergence adjustment in accordance with the control signal from the microprocessor 15, and the position of the pattern on the screen is adjusted.

Then, after the recognizable shape is formed at the present adjustment point on the screen, proper convergence adjustment for that adjustment point is complete. The user may then repeat this process for additional adjustment points. Once the user is satisfied with the convergence adjustment process, the user ends the convergence adjustment process by inputting a suitable command to the input device 14. The quantity of convergence adjustment at the adjustment points is stored in the memory 31. The convergence adjustment is then complete.

As described above, convergence adjustment may be performed on a plurality of adjustment points on the screen of the display device. An individual convergence adjustment is performed by the user for each adjustment point having poor convergence. Embodiments of the present invention enable a user to display and adjust patterns corresponding to two or more signals projected on the screen of the display device by two or more of R, G, and B projection tubes. The two or more patterns may have different characteristics such as, but not limited to, shape, size, color, fill pattern and orientation. The user may change the position of the two or more different shapes on the screen of the display device using, for example, a keyboard or remote control device. The user may easily and quickly determine when proper convergence between the two or more signals has been achieved by visually observing when a recognizable shape is formed by he two or more patterns.

In one embodiment, the recognizable shape may be an aggregate cross-shaped pattern formed by combining a cross-shaped pattern with one or more bar-shaped patterns. In other embodiments, the recognizable shape may be an aggregate cross-shaped pattern formed by combining two or more cross-shaped patterns consisting of blocks. The aggregate cross-shaped patterns may have substantially straight lines in the vertical and horizontal directions. In yet other embodiments, the recognizable shape may be an aggregate pattern consisting of a first pattern having a geometric-shaped opening substantially filled in by a second pattern having a geometric-shape of substantially the same dimensions as the opening. Embodiments of the present invention may employ any two or more differently shaped patterns that, when adjusted in a manner that indicates proper convergence, form a recognizable shape. Thus, embodiments of the present invention provide an apparatus and method for easily, quickly and accurately performing a convergence adjustment of two or more signals.

It is to be understood that even though numerous characteristics and advantages of various embodiments of the present invention have been set forth in the foregoing description, together with details of the structure and function of various embodiments of the invention, this disclosure is illustrative only. Changes may be made in detail, especially matters of structure and management of parts within the principles of the present invention to the full extent indicated by the broad general meaning of the terms in which the appended claims are expressed. For example, embodiments of the present invention are not limited to the projection television set described, but can apply to a large size television set having a CRT and to other applications for providing an image using a CRT or a projection tube. Further, according to embodiments of the present invention, the patterns described are used for convergence adjustment. However, it is possible to apply embodiments of the present invention to any signal adjustment requiring adjustment between plural signals.

Having disclosed exemplary embodiments and the best mode, modifications and variations may be made to the disclosed embodiments while remaining within the scope of the invention as defined by the following claims.

What is claimed is:

1. A pattern generating and adjustment apparatus for generating and adjusting patterns on a display, comprising:
a first pattern generator generating a first signal on the display as a first pattern;
a second pattern generator generating a second signal on the display as a second pattern; and
means for properly adjusting the first and second patterns on the display;
wherein a characteristic other than color of the first pattern is different from a corresponding characteristic of the second pattern and wherein when properly adjusted, the first and second patterns form an aggregate pattern having a recognizable shape.

2. The apparatus recited in claim 1, wherein the characteristic other than color comprises at least one of shape, size, fill pattern, and orientation.

3. The apparatus recited in claim 1, wherein the recognizable shape comprises a shape including at least one substantially straight line.

4. The apparatus recited in claim 1, wherein the recognizable shape comprises the first pattern having an opening with a particular shape, the opening being substantially filled by the second pattern, the second pattern having the particular shape.

5. The apparatus recited in claim 1, wherein the recognizable shape has at least a portion of the first pattern which does not overlap the second pattern.

6. The apparatus recited in claim 1, wherein the recognizable shape has no portion of the first and second patterns overlapping one another.

7. The apparatus recited in claim 1, wherein the adjustment is a convergence adjustment of the first and second patterns.

8. The apparatus recited in claim 1, wherein the first and second signals are separable pattern signals.

9. An apparatus having a display screen for displaying pattern signals, comprising:
a pattern generator generating and displaying a plurality of signals on the display screen as a plurality of patterns for adjustment, at least one of the plurality of patterns having at least one characteristic other than color different from at least one corresponding characteristic of at least one other of the plurality of patterns, the plurality of patterns forming, when properly adjusted, an aggregate pattern having a recognizable shape;
means for determining an adjustment quantity required for proper adjustment of the at least one of the plurality of patterns based on formation of the recognizable shape;
means for properly adjusting an alignment of the at least one of the plurality of patterns on the display screen according to the determined adjustment quantity; and
a memory for storing the adjustment quantity.

10. The apparatus recited in claim 9, wherein the characteristic other than color comprises at least one of shape, size, fill pattern, and orientation.

11. The apparatus recited in claim 9, wherein the recognizable shape comprises an aggregation of the plurality of patterns and has a cross shape including at least one substantially straight line.

12. The apparatus recited in claim 9, wherein the recognizable shape comprises an aggregation of the plurality of patterns, the at least one of the plurality of patterns having an opening with a particular shape, the opening being substantially filled by the at least one other of the plurality of patterns, the at least one other of the plurality of patterns having the particular shape.

13. The apparatus recited in claim 9, wherein when properly adjusted, at least a portion of the at least one of the plurality of patterns does not overlap the at least one other of the plurality of patterns.

14. The apparatus recited in claim 9, wherein the adjustment is a convergence adjustment of the plurality of patterns.

15. The apparatus recited in claim 9, wherein the plurality of signals are separable pattern signals.

16. The apparatus recited in claim 9, wherein the plurality of patterns are projected on the display screen by Green, Red and Blue projection tubes.

17. The apparatus recited in claim 9, wherein the means for determining the adjustment quantity comprise manual means.

18. The apparatus recited in claim 9, wherein the means for determining the adjustment quantity comprise inputting an image of the display screen to a processing device programmed to determine the adjustment quantity from the image.

19. The apparatus recited in claim 9, wherein the means for properly adjusting the alignment of the at least one of the plurality of patterns on the display screen comprise manually inputting the adjustment quantity using an input device.

20. The apparatus recited in claim 9, wherein the means for properly adjusting the alignment of the at least one of the plurality of patterns on the display screen comprise a processing device programmed to adjust the alignment according to the adjustment quantity.

21. A method for generating and adjusting patterns on a display, comprising:
generating a first signal on the display as a first pattern;
generating a second signal on the display as a second pattern; and
properly adjusting the first and second patterns on the display;
wherein a characteristic other than color of the first pattern is different from a corresponding characteristic of the second pattern and wherein when properly adjusted, the first and second patterns form an aggregate pattern having a recognizable shape.

22. The method recited in claim 21, wherein the characteristic of the first and second patterns comprises at least one of shape, size, fill pattern, and orientation.

23. The method recited in claim 21, wherein the recognizable shape comprises an aggregation of the first and second patterns and has a cross shape including at least one substantially straight line.

24. The method recited in claim 21, wherein the recognizable shape comprises an aggregation of the first and second patterns, the first pattern having an opening with a particular shape, the opening being substantially filled by the second pattern, the second pattern having the particular shape.

25. The method recited in claim 21, wherein when properly adjusted, at least a portion of the first pattern does not overlap the second pattern.

26. The method recited in claim 21, wherein the adjustment is a convergence adjustment of the first and second patterns.

27. The method recited in claim 21, wherein the first and second signals are separable pattern signals.

28. An apparatus having a display screen for displaying pattern signals, comprising:
means for generating and displaying a plurality of signals on the display screen as a plurality of patterns, at least one of the plurality of patterns having at least one characteristic other than color different from at least one corresponding characteristic of at least one other of the plurality of patterns, the plurality of patterns forming, when properly adjusted, an aggregate pattern having a recognizable shape;
means for determining an adjustment quantity required for proper adjustment of at least one of the plurality of patterns;
means for properly adjusting an alignment of the at least one of the plurality of patterns on the display screen according to the determined adjustment quantity; and
means for storing the adjustment quantity.

29. The apparatus recited in claim 28, wherein the characteristic comprises at least one of shape, size, fill pattern, and orientation.

30. The apparatus recited in claim 28, wherein the recognizable shape comprises an aggregation of the plurality of patterns and has a cross shape including at least one substantially straight line.

31. The apparatus recited in claim 28, wherein the recognizable shape comprises an aggregation of the plurality of patterns, the at least one of the plurality of patterns having an opening with a particular shape, the opening being substantially filled by the at least one other of the plurality of patterns, the at least one other of the plurality of patterns having the particular shape.

32. The apparatus recited in claim 28, wherein when properly adjusted, at least a portion of the at least one of the plurality of patterns does not overlap the other of the plurality of patterns of the plurality of patterns.

33. The apparatus recited in claim 28, wherein the adjustment is a convergence adjustment of the plurality of patterns.

34. A pattern generating and adjustment apparatus for generating and adjusting patterns on a display, comprising:
a first pattern generator generating a first signal on the display as a first pattern;
a second pattern generator generating a second signal on the display as a second pattern; and
means for properly adjusting the first and second patterns on the display;
wherein a characteristic of the first pattern is different from a corresponding characteristic of the second pattern and wherein when properly adjusted, the first and second patterns form an aggregate pattern having a recognizable shape, the recognizable shape having at least a portion of the first pattern which does not overlap the second pattern.

35. The apparatus recited in claim 34, wherein the characteristic comprises at least one of shape, size, fill pattern, color and orientation.

36. The apparatus recited in claim 34, wherein the recognizable shape comprises a shape including at least one substantially straight line.

37. The apparatus recited in claim 34, wherein the recognizable shape comprises the first pattern having an opening with a particular shape, the opening being substantially filled by the second pattern, the second pattern having the particular shape.

38. The apparatus recited in claim 34, wherein the adjustment is a convergence adjustment of the first and second patterns.

39. The apparatus recited in claim 34, wherein the first and second signals are separable pattern signals.

40. A pattern generating and adjustment apparatus for generating and adjusting patterns on a display, comprising:
a first pattern generator generating a first signal on the display as a first pattern;
a second pattern generator generating a second signal on the display as a second pattern; and
means for properly adjusting the first and second patterns on the display;
wherein a characteristic of the first pattern is different from a corresponding characteristic of the second pattern and wherein when properly adjusted, the first and second patterns form an aggregate pattern having a recognizable shape, the recognizable shape having no portion of the first and second patterns overlapping one another.

41. The apparatus recited in claim 40, wherein the characteristic comprises at least one of shape, size, fill pattern, color and orientation.
